(19) United States
(12) Patent Application Publication
(10) Pub. No.: US 2017/0353148 A1
(43) Pub. Date: Dec. 7, 2017

(54) EXTENDED PHOTOVOLTAIC MODULE FIXTURE

(71) Applicant: Soonchunhyang University Industry Academy Cooperation Foundation, Bucheon-si, Gyeonggi-do (KR)

(72) Inventor: Hyung Eui HONG, Gyeonggi-do (KR)

(21) Appl. No.: 15/544,760

(22) PCT Filed: Jan. 15, 2016
(86) PCT No.: PCT/KR2016/000445

§ 371 Date: Jul. 19, 2017

(30) Foreign Application Priority Data
Jan. 19, 2015 (KR) 10-2015-0008933

(51) Int. Cl. H02S 30/20; H02S 20/10; H02S 20/30; H02S 30/10

(52) U.S. Cl. CPC H02S 30/20; H02S 30/10; H02S 20/10; H02S 20/30

(57) ABSTRACT

An extended photovoltaic module unit comprises: a main body (10) having a first photovoltaic power generation module (1) fixed on a plurality of support parts (11) protruding from the upper surface thereof, and a third photovoltaic power generation module (3) slidably provided as a drawer type in an accommodation space (14) formed from the outer surface of one side thereof to the inside direction; a hinge part (20) formed at one side of an upper part of the main body (10); and an auxiliary body (30) having one side rotatably connected to the main body (10) via the hinge part (20), and having a second photovoltaic power generation module (2) fixed at a module supporting groove (31) of a lower end thereof.

### BACKGROUND

The present invention relates to an extended photovoltaic module unit. More particularly, the invention relates to an extended photovoltaic module fixture for installing photovoltaic modules, which allows a plurality of photovoltaic modules to be extended in a folding or sliding manner.

Generally, a method of employing solar energy is typically classified into a solar-heat employing method of performing heating and power generation by using water heated by the sun, and a solar-light employing method of electrically operating various kinds of machines and mechanisms by generating electricity using solar light.

The solar-light employing method is referred to as photovoltaic generation, and a photovoltaic generating unit is classified into a standalone photovoltaic generating unit and a grid-connected photovoltaic generating unit.

The standalone photovoltaic generating unit includes a solar-cell array (solar-cell panel) that is made by coupling a plurality of solar-cell modules composed of solar cells for generating power using solar light, a storage battery that stores power produced from the solar-cell panel, a power control device that controls to store power produced from the solar-cell panel at a constant level in the storage battery or to supply the power to an external load, an inverter that inverts direct current supplied from the storage battery and the power control device into alternating current, and an auxiliary generator. The photovoltaic generation has the following problems: a large installation area is required because of low energy density, and a space for installing a solar-cell panel should be secured because of a limited installation place.

In order to secure an area for installing the photovoltaic module, it may be considered to install the module in a place having a lot of sunshine and a wide open area, for example, a water surface of the river, the lake, a reservoir, a dam or the like. In this case, a ship should be used to install the photovoltaic module in the water surface or perform maintenance, so that mobility is undesirably limited.

The inventor has proposed a photovoltaic module fixture intended to install the fixture fixing a photovoltaic module on the water or on land as in Patent Document 1 or Patent Document 2.

That is, Patent Document 1 relates to a water photovoltaic module-integrated buoyant body, in which buoyant bodies coupled at top surfaces thereof with photovoltaic cell modules are arranged in a row or from front to back and side to side, and are connected to each other in a water surface of the river, the lake, a reservoir, a dam or the like, and then a buoyant body located at an edge is fixed to a fixing pillar, so that, when a height is variably adjusted depending on a change in water level, the photovoltaic module concentrates solar light while maintaining a float state to generate power, and an interval is maintained by a spacing protrusion formed on the buoyant body, thus preventing the photovoltaic cell module from being shaded. Patent Document 2 relates to a fixing structure for a land photovoltaic module, including a fixture on which a photovoltaic cell module may be obliquely mounted, a support which has on one side thereof a first hole to fixedly come into contact with a side surface of a lower portion of the fixture and has on the other side thereof a second hole to fixedly come into contact with a ground, and an anchor pile which has a predetermined length to pass through the second hole and be laid under the ground.

However, the photovoltaic module fixtures of Patent Document 1 and Patent Document 2 are problematic in that one photovoltaic module is fixed to one fixture unit, so that an occupied space is limited when a plurality of photovoltaic modules is installed, and an amount of produced power is limited in a single fixture.

### CITED REFERENCES

Korean Patent No. 10-1339358 (published on Dec. 9, 2013)
Korean Patent No. 10-1312027 (published on Sep. 26, 2013)

### SUMMARY OF THE INVENTION

Accordingly, the present invention has been made keeping in mind the above problems occurring in the related art, and an aspect of the present invention is directed to an extended photovoltaic module fixture, which allows a plurality of photovoltaic modules to be installed to one fixture, and connects respective photovoltaic modules to each other in a folding or sliding manner, thus allowing the photovoltaic modules to be extended.

In order to accomplish the object, the present invention provides an extended photovoltaic module fixture, including a main body having a first photovoltaic power generation module fixed on a plurality of support parts protruding upwards from an upper surface thereof, and a third photovoltaic power generation module slidably provided as a drawer type in an accommodation space formed inwards from an outer surface of one side thereof; a hinge part formed at one side of an upper part of the main body; and an auxiliary body having one side rotatably connected to the main body via the hinge part, and having a second photovoltaic power generation module fixed at a module supporting groove of a lower end thereof, wherein the first module and the second module face each other when the auxiliary body is located at an upper side of the main body, and each module is in a power generation state when the auxiliary body rotates around the hinge part and spreads on the main body or when the third module is taken out from the accommodation space.

According to the present invention, one side of an upper portion of a fixture is foldably connected to one end of a photovoltaic module, and simultaneously a photovoltaic module is slidably installed in the fixture, thus allowing a plurality of photovoltaic modules to be simultaneously installed in one fixture and to be extended if necessary, therefore facilitating conveyance and installation, minimizing an occupied space, reducing the manufacturing cost of the fixture, and consequently increasing economic efficiency and productivity.

### BRIEF DESCRIPTION OF THE DRAWINGS

FIG. 1 is a perspective view illustrating a spread state of an extended photovoltaic module fixture according to the present invention.

FIG. 2 is a perspective view illustrating a non-spread state of the extended photovoltaic module fixture according to the present invention

FIG. 3 is an exploded perspective view illustrating the extended photovoltaic module fixture according to the present invention.

FIG. 4 is an exploded perspective view illustrating essential parts of the extended photovoltaic module fixture according to the present invention.

FIG. 5 is a perspective view illustrating a connected and installed state of the extended photovoltaic module fixture according to the present invention.

FIG. 6 is a perspective view illustrating a photovoltaic module (third module) according to another embodiment of the present invention.

FIG. 7 is an exploded perspective view illustrating an extended photovoltaic module fixture according to another embodiment of the present invention.

FIG. 8 is a perspective view illustrating a non-spread state of the extended photovoltaic module fixture according to another embodiment of the present invention.

FIG. 9 is a view illustrating a structure of an extended photovoltaic module fixture according to a further embodiment of the present invention.

### DETAILED DESCRIPTION OF THE INVENTION

Hereinafter, preferred embodiments of the present invention will be described in detail with reference to the accompanying drawings. However, since the embodiments merely aid in understanding the present invention, they are not intended to limit the present invention. A detailed description of technology that is obvious to those skilled in the art or is readily obtained will be omitted herein.

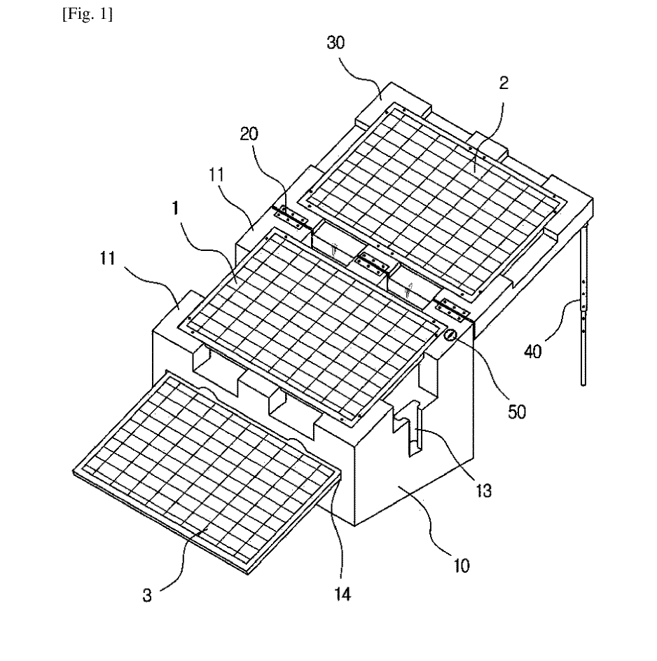

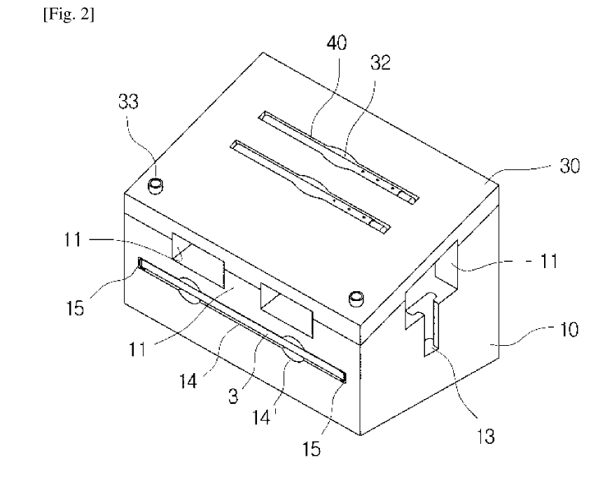

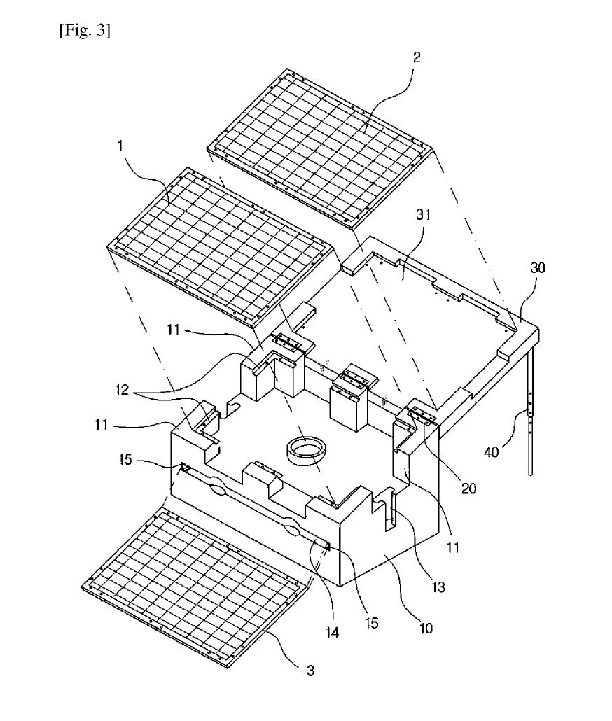

FIG. 1 is a perspective view illustrating a spread state of an extended photovoltaic module fixture according to the present invention, FIG. 2 is a perspective view illustrating a non-spread state of the extended photovoltaic module fixture according to the present invention, and FIG. 3 is an exploded perspective view illustrating the extended photovoltaic module fixture according to the present invention.

Referring to FIGS. 1 to 3, the extended photovoltaic module fixture of the present invention includes a main body 10, a hinge part 20, and an auxiliary body 30. By these elements, a first module 1, a second module 2 and a third module 3, which are power generating units using solar light, are installed.

The main body 10 may be made of synthetic resin, for example, and may have a space therein to serve as a buoyant body, with a plurality of support parts 11 being formed on an upper surface thereof to protrude upwards. A module support step 12 may be formed on each the support part 11 to seat the first module 1 thereon, so that the first module 1 may be fastened via a screw or the like when it is seated on the module support step 12.

An inlet of an accommodation space 14 is formed in an outer surface of one side of the main body 10, the accommodation space 14 is formed from the inlet to the inside of the main body 10, and a third photovoltaic power generation module 3 is slidably provided as a drawer type in the accommodation space 14. That is, the third module 3 may be taken out from the main body 10 as illustrated in FIG. 1, and may be put and stored in the accommodation space 14 of the main body 10 as illustrated in FIG. 2.

For example, the hinge part 20 is used to join two elements so that they may rotate. The shape and structure of the hinge part are not limited to an illustrated example.

The auxiliary body 30 may be made of synthetic resin similarly to the main body, and may have a space therein to be used as a buoyant body. It should be noted that the present invention does not limit the material or shape of the auxiliary body 30.

One side of the auxiliary body 30 is rotatably connected to the main body 10 via the hinge part 20, and a module supporting groove 31 is formed in a lower end [the lower end is defined with respect to FIG. 2 in which the auxiliary body 30 is placed over the main body 10] of the auxiliary body 30. The third module 3 that is the photovoltaic power generating unit is fastened via a screw or the like in the state where the third module is seated on the module supporting groove 31.

Since the auxiliary body 30 may rotate about the hinge part 20 as an axis, the auxiliary body may be located above the main body 10 to cover a top of the main body 10 as illustrated in FIG. 2, or may be spread from the main body 10 as illustrated in FIG. 1.

Here, when the auxiliary body 30 is located above the main body 10, the first module 1 and the second module 2 face each other to be protected from external factors.

In contrast, when the auxiliary body 30 rotates about the hinge part 20 as the axis and spreads over the main body 10, the first module 1 and the second module 2 are ready to generate power by solar light. Further, when the third module 3 is taken out from the accommodation space 14, power may also be generated by the third module 3.

Thus, the state (non-spread state) of FIG. 2 is suitable when the photovoltaic module is conveyed to or stored in an installation place, and the state (spread state) of FIG. 1 is a state where photovoltaic power generation is performed after installation.

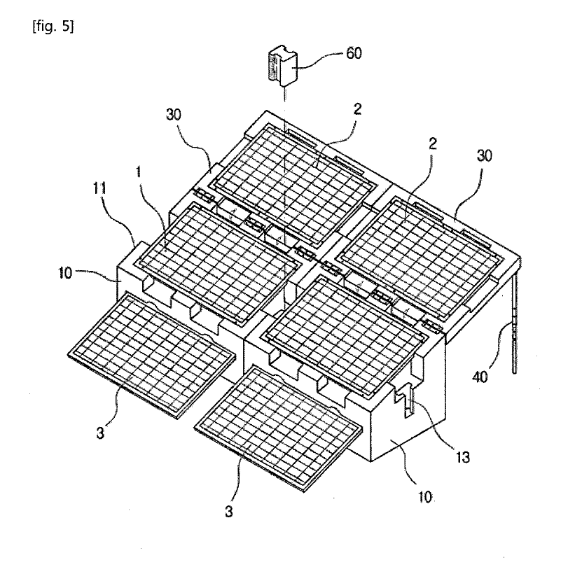

Meanwhile, a ‘T’-shaped connecting groove 13 may be formed on an outer surface of one side of the main body 10 when observed from above. This will be described below in detail with reference to FIG. 5.

When the auxiliary body 30 is spread out, a free end of the auxiliary body 30, namely, an opposite end thereof that is not connected with the hinge part 20 may be inclined or sag by the load of the auxiliary body 30, it is preferable to install a support leg 40 for holding and supporting the free end of the auxiliary body 30. The support leg 40 may adopt a length varying structure, such as an antenna structure or a fishing rod, for example.

In order to stably install the support leg 40, a support-leg holding hole 33 may be formed in the free end of the auxiliary body 30 to insert and hold one end of the support leg 40. Of course, the location of the support-leg holding hole 33 is not limited to an illustrated shape, and the shape of the support-leg holding hole may be variously changed as long as it is possible to hold the support leg 40.

In order to prevent the support leg 40 from being lost, a support-leg storage groove 32 may be formed in an upper end [the upper end is defined with respect to FIG. 2 in which the auxiliary body 30 is placed over the main body 10] of the auxiliary body 30 to put and store the support leg 40 therein. Although not shown in the drawings, a cover may be further provided on the storage groove 32 so as to prevent the removal of the support leg 40.

As illustrated in the drawings, the photovoltaic module fixture of the present invention may be inclined at an upper surface thereof. Here, the inclined portion should face to the south. In order to easily set a direction when the fixture is installed, a compass 60 may be installed at a position on an upper surface of the main body 10.

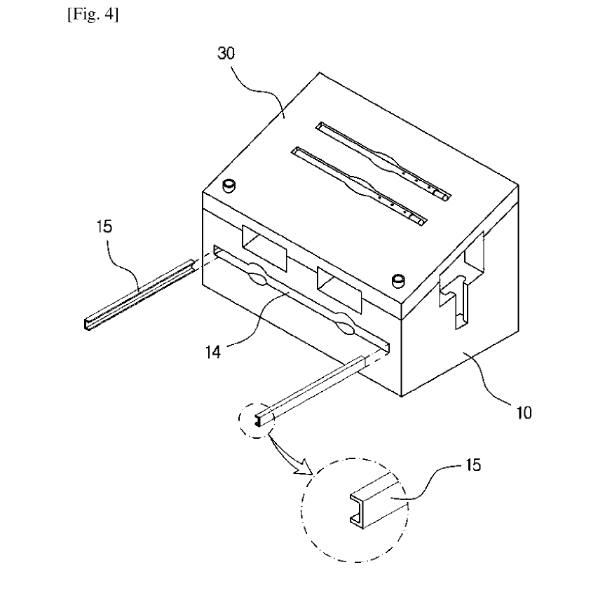

FIG. 4 is an exploded perspective view illustrating essential parts of the extended photovoltaic module fixture according to the present invention. This illustrates a state in which guide bars 15 of the third module are separated.

Referring to FIG. 4, the accommodation space 14 may have the shape of a rectangle that is long in a horizontal direction when viewed from a front. The guide bars 15 may be provided on both ends in a longitudinal direction of the accommodation space 14 to come into contact with both ends of the third module 3 and thereby guide the sliding operation of the third module 3.

As illustrated in an enlarged view, the guide bar 15 has a ‘ [symbol] ’-shaped cross-section and a predetermined length. When a pair of guide bars 15 is installed at both ends of the accommodation space 14, the guide bars 15 are installed such that openings thereof face each other. The guide bar 15 is made of a metal material. In this case, when the third module 3 slides, a smooth slide is achieved while reducing abrasion by friction.

FIG. 5 is a perspective view illustrating a connected and installed state of the extended photovoltaic module fixture according to the present invention.

As described above, the ‘T’-shaped connecting groove 13 that is open at a top may be formed on an outer surface of one side of the main body 10. In this case, a plurality of main bodies 10 may be connected to each other via a connector 60 having a ‘I’-shaped cross-section. That is, as illustrated in the drawing, the connecting grooves 13 of the respective main bodies 10 face each other when two main bodies 10 come into contact with each other. If the connector 60 is inserted into a facing connecting groove 13, it is possible to fix two main bodies 10. In this way, it is possible to successively install a plurality of main bodies 10.

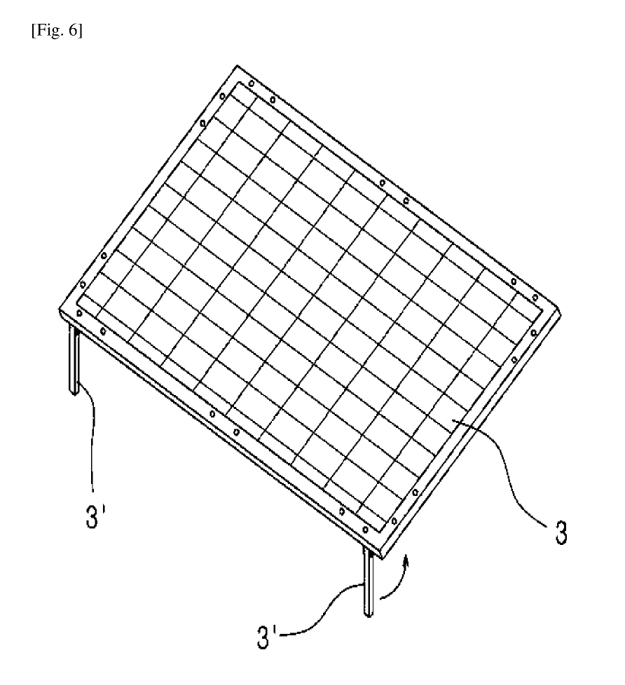

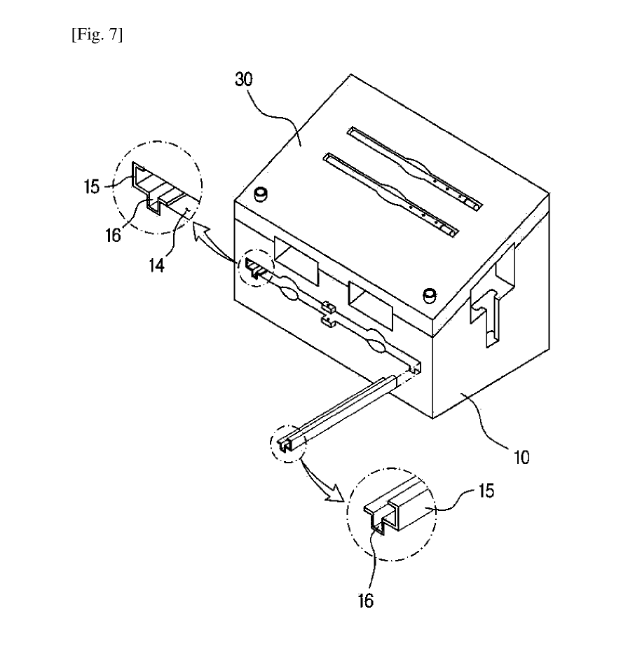

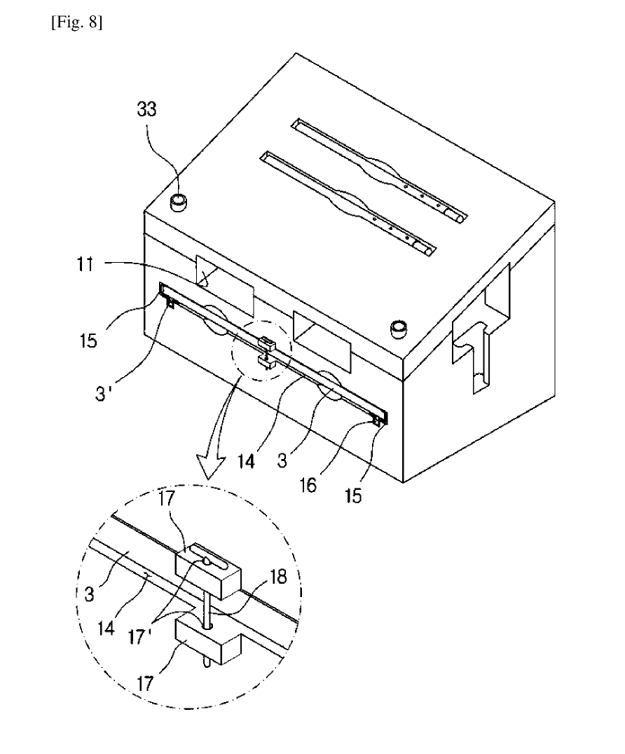

FIG. 6 is a perspective view illustrating a photovoltaic module (third module) according to another embodiment of the present invention, FIG. 7 is an exploded perspective view illustrating an extended photovoltaic module fixture according to another embodiment of the present invention, and FIG. 8 is a perspective view illustrating a non-spread state of the extended photovoltaic module fixture according to another embodiment of the present invention.

Referring to FIGS. 6 to 8, a foldable auxiliary leg 3′ is provided on one side of the third module 3 that slides like a drawer. Thus, when the third module 3 is taken out from the main body 10, the auxiliary leg 3′ may be spread to support the free end. In contrast, when the third module 3 is put into the accommodation space 14, the auxiliary leg 3′ may be put in a folded state.

Here, a ‘U’-shaped leg accommodation space 16 may be further formed in a lower portion of the guide bar 15 to accommodate the foldable auxiliary leg 3′ in a folded state.

Projections 17 having vertically formed holes 17′ are provided on upper and lower sides of an inlet of the accommodation space 14, and a ‘T’-shaped or ‘ [symbol] ’-shaped locking pin 18 is inserted into the holes 17′. In this case, it is possible to prevent the third module 3 stored in the accommodation space 14 from being removed from the accommodation space 14 by the locking pin 18.

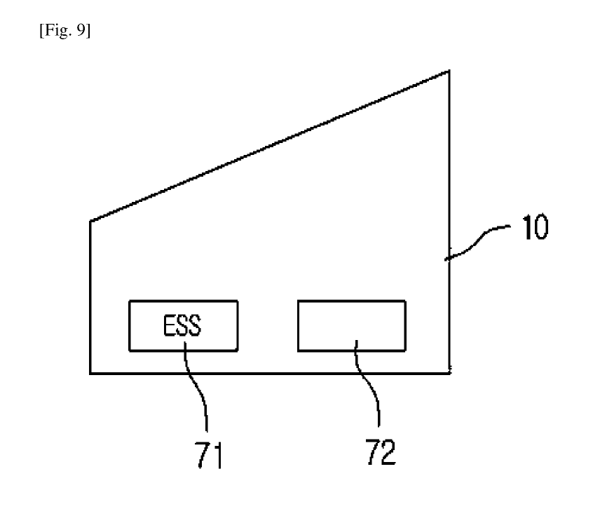

FIG. 9 is a view illustrating a structure of an extended photovoltaic module fixture according to a further embodiment of the present invention.

Referring to FIG. 9, an energy storage system (ESS) 71 for storing power produced from the first, second and third modules 1, 2 and 3 like a battery and an inverter 72 are installed in the main body 10.

The inverter 72 compares power produced from the first, second and third modules 1, 2 and 3 with demand power and then stores surplus power in the energy storage system 61. Further, the inverter may control to use power stored in the energy storage system 61 as the demand power if the demand power is larger than the produced power.

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

While the present invention has been described with respect to the specific embodiments, it will be apparent to those skilled in the art that various changes and modifications may be made without departing from the spirit and scope of the invention as defined in the following claims.

[Reference Numerals]

| | |
|---|---|
| 1: First module | 2: Second module |
| 3: Third module | 3′: Auxiliary leg |
| 10: Main body | 11: Support part |
| 12: Module support step | 13: Connection groove |
| 14: Accommodation space | 15: Guide bar |
| 16: Leg accommodation space | 17: Projection |
| 17′: Hole | 18: Locking pin |
| 20: Hinge part | 30: Auxiliary body |
| 31: Module support groove | 32: Storage groove |
| 33: Leg locking groove | 40: Support leg |
| 50: Compass | 60: Connector |
| 71: Energy storage system(ESS) | 72: Inverter |

1. An extended photovoltaic module fixture, comprising:
a main body having a first photovoltaic power generation module fixed on a plurality of support parts protruding upwards from an upper surface thereof, and a third photovoltaic power generation module slidably provided as a drawer type in an accommodation space formed inwards from an outer surface of one side thereof;
a hinge part formed at a side of an upper part of the main body; and
an auxiliary body having a side rotatably connected to the main body via the hinge part, and having a second photovoltaic power generation module fixed at a module supporting groove of a lower end thereof,
wherein the first module and the second module face each other when the auxiliary body is located at an upper side of the main body, and each module is in a power generation state when the auxiliary body rotates around the hinge part and spreads on the main body or when the third module is taken out from the accommodation space,
a ‘T’-shaped connecting groove that is open at an upper surface thereof is formed in an outer surface of a side of the main body to connect a plurality of main bodies to each other via a connector having a ‘I’-shaped cross-section,
the accommodation space is a shape of a rectangle that is long in a horizontal direction when viewed from a front, and ‘ [symbol] ’-shaped guide bars are provided on both ends in a longitudinal direction of the accommodation space to come into contact with both ends of the third module and guide the third module, the guide bars being arranged such that openings thereof face each other, and
projections having vertically formed holes are provided on upper and lower sides of an inlet of the accommodation space, and a locking pin is inserted into the holes to prevent a removal of the third module.

2. The extended photovoltaic module fixture of claim 1, further comprising:
a support leg supporting a free end of the auxiliary body when the auxiliary body is spread.

3. The extended photovoltaic module fixture of claim 2, wherein a support-leg holding hole is formed in the free end of the auxiliary body to hold an end of the support leg.

4. The extended photovoltaic module fixture of claim 2, wherein a support-leg storage groove is formed in an upper end of the auxiliary body to store the support leg.

5. The extended photovoltaic module fixture of claim 1, wherein a compass is provided on a side of an upper surface of the main body.

6. The extended photovoltaic module fixture of claim 1, wherein a foldable auxiliary leg is provided on a side of the third module to support the free end when the third module is spread, and a ‘U’-shaped leg accommodation space is further formed in a lower portion of the guide bar to accommodate the foldable auxiliary leg in a folded state.

7. The extended photovoltaic module fixture of claim 1, wherein an energy storage system for storing surplus power produced from the first, second and third modules and an inverter for controlling to store power in the energy storage system or use the stored power are provided in the main body.
